(19) United States
(12) Patent Application Publication
(10) Pub. No.: US 2005/0229481 A1
(43) Pub. Date: Oct. 20, 2005

(54) Colored Plastic Mulches and Geotextiles Imprinted and Embossed with Natural Images

(75) Inventor: Charles Lindsay Wilson, Shepherdstown, WV (US)

Correspondence Address: CHARLES LINDSAY WILSON, BOX 1194, SHEPERDSTOWN, WV, 25443, US

(73) Assignee: Charles Lindsay Wilson, Shepherdstown, WV (US)

(21) Appl. No.: 10/907,827

(22) Filed: Apr. 17, 2005

Related U.S. Application Data
(60) Provisional application No. 60/521,397, filed on Apr. 17, 2004.

(51) Int. Cl. A01G 13/02

(52) U.S. Cl. 47/9

(57) ABSTRACT

The present invention imparts a natural mulch image and color to the surface of plastic mulches and geotextiles. Such images as natural shredded bark are imprinted and/or embossed on colored plastic mulch and geotextile surfaces. Plastic mulches are generally covered with natural mulch materials that often shift, exposing the plastic surfaces. This invention eliminates the unsightliness resulting from this phenomenon. Use of plastic mulches and geotextiles with natural mulch colors and images reduces the amount of natural mulch required to cover the plastic mulch or geotextile underlayment, resulting in reduced cost and reduced weed reinfestation.

### BACKGROUND

Plant mulches can be either organic or inorganic. Organic mulches are derived from plant or animal materials and have long been used in agriculture primarily to control weeds and soil moisture. Organic mulches most frequently used include plant residues such as shredded bark, straw, hay, peanut hulls, leaf mold, and compost. Plastic mulches and geotextiles (also called landscape fabrics or weed barriers) are used extensively in agriculture and landscaping to improve plant growth and facilitate maintenance. These ground covers can suppress competing vegetation (weeds, grass), warm the soil to promote earlier spring growth, delay soil freezing and prevent frost heaving in the winter, protect plants from damage by equipment, reduce soil erosion and loss, hold moisture, reduce evaporation and runoff, enhance garden and landscape appearance, and make garden and landscape maintenance easier.

Plastics used to manufacture mulch films are generally low density polyethylene poly(vinyl chloride), polybutylene, or copolymers of ethylene with vinyl acetate. Plain black plastic has long been the mulch of choice, but in warmer climates white plastic is often used to reduce otherwise-excessive soil temperatures. Plastic mulches and geotextiles can be colored by mixing color pigments with polymer resins during the extrusion process. Recently, it has been discovered that colored mulches reflect particular wavelengths of sunlight back up onto the leaves of the plant above them. Also, individual plants respond differently to different colored plastic mulches.

Green plastic mulch is widely used on peppers, cantaloupes, watermelons and other vine crops. Depending on weather conditions, using green plastic results in a five to ten day earlier crop harvest than black mulch. There is also an increase in yields. Tomatoes grown on red plastic mulch have higher yields, stronger stems, and ripen earlier. Research has also shown that red mulch reduces nematode damage. The plant responds to the high proportion of reflected far-red mulch by growing taller and putting out more leaves. Silver colored mulch has been shown by researchers to increase tomato yields 50% and pepper yields 65%. The test also showed sharp reduction in the population of white flies and aphids on these plants.

Most landscape maintenance programs rely on hand weeding, herbicides, and mulches (alone or in combination) to suppress and control weeds. Black plastic has traditionally been used to suppress and control weeds. Traditional organic mulches such as shredded bark are placed over the plastic mulch for aesthetic purposes. But, several studies have reported adverse effects on landscape plant growth due to this combination. Landscape architects and gardeners are turning more to geotextiles than plastic films and sheets for landscape plants. Perforated, thermally spun-bonded or woven polypropylene or polyester landscape fabrics (geotextiles) are more durable than plastic mulch films and they are more permeable to moisture and air. Some geotextiles are needle punched to allow moisture and air exchange between the soil and atmosphere. Traditional organic mulches (pine bark, pine straw, hardwood bark, etc.) are also placed over geotextiles to impart a natural appearance to the landscape.

Major problems have been observed when organic materials are combined with geotextiles. Weeds begin to grow in the natural mulch after it is installed, even when all existing weeds have previously been eradicated from the site. Contamination may originate from weed seed carried in the mulch or introduced via wind or irrigation water.

Another problem results when the natural mulch that covers the landscape fabric shifts and exposes the “unnatural” geotextile. Embossed plastic mulches have been developed that attempt to address this problem by imprinting a pattern into the geotextile that allows it to stretch and conform more to the soil surface.

Byrne [U.S. Pat. No. 5,396,731] describes a mulch pad consisting of a mixture of rubber granules, buffings, and fibers ground from used tires. The pad that encircles the base of a tree is porous and allows moisture and air transmission to the underlying root system. The pad has color and texture resembling a natural bark mulch appearance. It is limited in its application to the immediate vicinity of trees and other plants.

Fouan [U.S. Pat. No. 6,622,424 B1] describes a ground cover comprising a mixture of natural plant fibers and binder that agglomerates the fibers into a pasty layer capable of taking the shape of the land when it is applied. This mulch requires a specialized mixing and application procedure.

Ali et al. [U.S. Pat. No. 6,672,001 B1] describes a mulch for agricultural soil beds utilizing a biodegradable protein mulch material. The film-forming protein solution is sprayed directly onto the surface of an agricultural soil bed. Following harvest the mulch material which is biodegradable may be plowed under. Such a mulch would not be appropriate for perennial or landscape plants.

Labbie et al. [U.S. Pat. No. 6,401,390 B1] describes a multilayered, coated mulch having a preprogrammed biodegradability. It consists of two different layers of a biodegradable polymer coated onto a sheet of cellulosic material, one of these layers being polylactide. The mulch can be programmed according to soil, climate, and the specific application. Such a mulch is not suitable for broad application.

Kitamura et al. [U.S. Pat. No. 4,920,692] describes a mulching film for repelling insects, as well as, lowering underground temperatures and preventing weed growth. This plastic mulch has a reflective film layer that repels insects.

Peled et al. [U.S. Pat. No. 6,601,338 B1] describe a multilayered plastic mulch with an upper layer facing the sky and a lower layer facing the ground. Each of the layers is a different color and each is light transmissive. The upper layer (yellow) is a color that repels insects and the lower layer (black) is a color that will retard weed growth.

Many different kinds of plastic mulch materials are available in widths from 36 to 60 inches and thicknesses from ¾ to 1½ mil or more. The surface texture may be slick or embossed. Plastic mulches are sometimes embossed with a pattern that gives them a wrinkled appearance. This kind of plastic mulch is generally more resistant to wind fatigue and cracking than slick plastics. Embossed plastic mulches are in general stronger and tend to conform better to soil surfaces. Other types of mulch, called “linear low density” types, have a slick appearance, but may have what appears to be parallel lines across the surface forming diamond-shaped patterns. None of the present plastic mulches are embossed to emulate natural mulches such as shredded bark.

Mulches applied to the soil as slurries contain natural fibers but do not appear as naturally mulched surfaces. The mulch pad as described by Byrne [U.S. Pat. No. 5,396,731] has been colored and textured to emulate natural shredded bark mulch. However, this pad composed of shredded used tires is limited in its application to the immediate proximity of a tree or other plant.

Although a variety of plastic mulches and geotextiles have been patented, none of this art attempts to modify the appearance of plastic mulches or geotextiles to make them appear as natural mulches.

The present invention imparts a natural mulch appearance to synthetic plastic mulches and geotextiles by pigmenting the plastic polymer with colors corresponding to a natural mulch and imprinting, and/or embossing natural mulch images and shapes onto its surface.

### SUMMARY OF INVENTION

The objective of the present invention is to modify the surface and color of plastic mulches and geotextiles so that they appear as natural mulches. This is accomplished by pigmenting the mulches and geotextiles with natural mulch colors and imprinting, layering, or embossing images of natural mulches such as shredded pine bark, hardwood bark, pine straw, etc. onto the surface of plastic mulches and geotextiles.

Natural mulch is customarily added to the surface of plastic mulches and geotextiles to cover the unsightly plastic for aesthetic purposes. Under such circumstances it is common for the natural mulch to shift, exposing unsightly bare areas of plastic. The present invention solves this problem by modifying the plastic mulch or geotextile so that it has the appearance of a natural mulch.

Heavy layering of natural mulch on the surface of plastic mulches and geotextiles often results in the reinfestation of the area with weeds even after all weeds have been removed from the site. Because of the natural mulch appearance of the plastic mulch and geotextile underlayment in the present invention, only a sparse layer of natural mulch needs to be applied on top of the plastic mulch or geotextile thus reducing reinfestation of the site with weeds.

### DETAILED DESCRIPTION OF INVENTION

In the present invention, plastic mulches and geotextiles are pigmented with colors corresponding to natural mulches and imprinted and/or embossed with images of natural mulches such as, but not limited to, shredded hardwood bark, shredded softwood bark, wood chips, pine straw, sawdust, hulls, lawn clippings, leaves, straw, peat moss, and crushed stone and gravel.

Plastic agricultural mulch film or sheets are generally made of a cast embossed or smooth blown pigmented polyolefins, co- or terpolymers, and vinylester copolymers, such as polyethylene (i.e., LDPE), polyethylene/ethylene, vinyl acetate, polypropylene or fluoropolymers, co- or terpolymers such as polytetrafluoro-ethylene (PTFE) and polyvinylchloride (PVC), polycarbonate (PC), polymethylacrylate (PMMA) or mixtures of the above as known to the art. Polymeric thin films for mulching are generally 0.5 mil to 4 mils in thickness (1 mil=0.001 inches).

The natural mulch images in the present invention can be created in a variety of ways. A preferred method is by pigmentation of the plastic mulch or geotextile with a natural mulch color and embossing it with natural mulch shapes or imprinting a natural mulch image on the surface of the plastic. Naturally colored plastic mulches and geotextiles can also be imprinted with a natural mulch image and embossed with natural mulch shapes.

Any of the variety of printing process known to the art can be used to print natural mulch images on the surfaces of plastic mulches and geotextiles, including offset lithography, web printing, letterpress, flexography (Flexo), gravure, screen printing, waterless lithography, and digital printing.

The flexographic printing process is a preferred embodiment of this invention because of its speed and efficiency. It is preferred that the printing be performed on a web press set up for roll to roll printing. Embossing wheels known to the art can be placed on the same web to emboss natural mulch shapes into the plastic mulch or geotextile.

Other methods can be used to transfer a desired natural image to the surface of a plastic mulch or geotextile, such as those used for instant lettering systems. In this case the image is transferred by applying pressure to the rear surface of the plastic sheet having the image so the bonding agent or adhesive is transferred to the surface with the image bonded to it. The method described by Mabbott [U.S. Pat. No. 6,198,898 B1) for printing monochrome and color images onto a surface is also applicable.

Plastic agricultural mulches and geotextiles are embossed presently to give them added strength and to cause the plastic mulch to stretch and conform more to land surfaces. Embossing can be done on cast film hot out of the die. In the case of film created by the blown film process, the pattern is imprinted into cold plastic after the plastic is formed.

A variety of methods are known to the art for embossing mulch film or sheets so that they will have textured surfaces. This methodology can be used to emboss appropriate shapes in the plastic mulch or geotextile such as that of shredded hardwood bark, shredded pine bark, wood chips, pine straw, sawdust, peat moss, and crushed stones and gravel. Color pigments are mixed with the plastic polymer to impart a natural color corresponding to natural mulch that is being emulated.

When the plastic mulch or geotextile of the present invention is applied to soil surfaces, its natural mulch appearance prevents unsightly areas from becoming apparent where the overlaying natural mulch is sparse. The present invention also allows the application of less natural mulch over the plastic mulch or geotextile resulting in reduced cost and less reinfestation by weeds.

1. Plastic mulches and landscape fabrics (geotextiles) imprinted and/or embossed on the surface with natural mulch images where the natural image is, but not limited to, shredded hardwood bark, shredded softwood bark, bark chunks, bark granules, wood chips, leaf mold, compost, lawn clippings, pine straw, sawdust, peat moss, coca shells, buckwheat hulls, peanut hulls, wood chips, crushed stones, gravel, or volcanic rock.

2. Plastic mulches and landscape fabrics (geotextiles) in claim 1 pigmented with natural mulch colors corresponding to the natural mulch image that is being emulated.
